(19) United States
(12) Patent Application Publication
(10) Pub. No.: US 2013/0022947 A1
(43) Pub. Date: Jan. 24, 2013

(54) METHOD AND SYSTEM FOR GENERATING BEHAVIORAL STUDIES OF AN INDIVIDUAL

(71) Applicants: Fernando Moreira Muniz SIMAS, Santiago (CL); Pepijn Van Der Krogt, Santiago (CL)

(72) Inventors: Fernando Moreira Muniz SIMAS, Santiago (CL); Pepijn Van Der Krogt, Santiago (CL)

(21) Appl. No.: 13/189,249

(22) Filed: Jul. 22, 2011

(51) Int. Cl. G09B 19/00

(52) U.S. Cl. 434/236

(57) ABSTRACT

System and method of data collection in a virtual environment to study the behavior of a user regarding the virtual environment stimuli, comprising: Peripheral Control Devices, Peripheral Representation Devices, and Peripheral Capture Devices; a Processor, for processing information of the virtual environment and the behavior of the user; a storage medium, configured with an Application module to provide the virtual environment; a dedicated storage medium, for storing a database with information provided by the Application module of the virtual environment and the behavior of said user; and Visualization means configured to display graphical representation of said user behavior illustrated by a Core On-Line Module with the database through dedicated storage; wherein said peripheral devices include a virtual reality lens, portable headphones and a peripheral capture device for a eye tracking, to record the eye movement of said user in this virtual environment, within the virtual reality lens.

### APPLICATION FIELD

The present invention relates to a method and system for generating behavioral studies of an individual. In particular, the present invention is a method and system of flexible and immersive data collection in a virtual environment to study the behavior of an individual with respect to stimuli in this virtual environment.

The present invention has particular application in marketing research to study the behavior of an individual as a consumer in a virtual environment, representing a point of exposure (usually—but not exclusively—outlets like in a supermarket) allowing to analyze the arrangement of items of interest in the structures of this exposure and the effect of this provision on the individual.

Manufacturers of fast moving consumer goods invest large amounts of money developing and researching their products, their packaging and their location in the stores where they will be displayed. For that, these manufacturers require several market and consumer researches. Usually, these consumer researches are based on questionnaires and focus groups. Today, technology has allowed the development of a different approach to analyze the behavior of a consumer through the virtual reality and biometric devices to record and to interpret the consumer.

### BACKGROUND OF THE INVENTION

At present there are different solutions for the study of the behavior of individuals in virtual environments. For example, the patent application WO2008/081.413 discloses a virtual reality system that includes a device equipped and used for a participant to present a simulation of a virtual shopping environment. Participant interactions with the virtual purchase environment can be used to generate market research on the process of consumer decision-making. The virtual shopping environment may include one or more intelligent systems configured to be responsive to participant interaction. The virtual shopping environment recreates a real world purchase environment and for the data collection an eye-tracking device is used. This invention uses an eye-tracking like EyeTech OneGlance® Digital System to record the visual tour generated by the user, this device uses at least one camera that determines the orientation of the pupil of the user requiring the user to stay within field of view of the device and restricts the freedom of the user to alter the results of the resulting studies.

WO2008/030,542 patent application discloses a method for studying the behavior of a consumer's emotional responses measured by visual stimuli, in a first aspect, the method includes the steps of: presenting a visual stimulus to a consumer, collection of data of the consumer's eye while watching the visual stimuli presented to the consumer, collecting biometric and eye-data while the stimulus is presented visually to the consumer, depending on zones and the time the consumer lookes. This document discloses a method that remotely collects data from staring and biometrics of a user, which requires sophisticated sensors that require the user to keep his eyes focused on these sensors. It is needed to use different technology and methodology in the field of production of virtual environments in real time to have a flexible and immersive custom application of a system and method of data collection in a virtual environment to study the behavior of an individual who is flexible enough to immersive to develop a to a virtual environment for an accurate analysis of the behavior of a consumer.

A point of sale as a shop or supermarket, can be easily described using a completely realistic Virtual Reality, where the advertising of products can be published and illustrated so that a user is exposed to these stimuli without having to launch a production of a real life shop, which would be necessary to generate researches with questionnaires and focus groups.

### SUMMARY OF THE INVENTION

The present invention provides a data collection system in a virtual environment, to study the behavior of a user regarding stimuli in the virtual environment, which is sufficiently flexible and immersive as to develop a custom application, allowing an accurate analysis of the behavior of a consumer. Therefore, the system provides a tool for behavioral analysis of individuals that allows the generation and interpretation of many variables due to the control and access to all information that represents the virtual reality, these variables include the individual's exact position and direction of, the body, head and eyes, the exact position of every object and structure shown in 3D and captures real-time behavior. These variables allow conclusions to provide a basis for future decision-making. The present invention allows for different levels of studies on types of arrangements (layouts), point of sale, old designs, or new combinations, different products, etc. And all produced by one system, the cost of both development and implementation is relatively much lower than other alternatives in proportion to the results to be obtained finally, thanks to a more complete and natural virtual environment.

### BRIEF DESCRIPTION OF THE DRAWINGS

FIG. 1 illustrates devices of the system according to the present invention.

FIG. 2 illustrates the components of the application module of the system according to this invention.

FIG. 3 illustrates the components of the on-line module of the system according to the present invention.

FIG. 4 illustrates the capture module of the system according to this invention.

FIG. 5 illustrates the On-line module of the system according to the present invention.

FIG. 6 illustrates the abstraction layer of functionality module of the system according to this invention.

FIG. 7 illustrates the communication protocol module of the system according to the present invention.

FIG. 8 illustrates the Management Interface of the system according to the present invention.

FIG. 9 illustrates the client interface system according to the present invention.

FIG. 10 illustrates the display module of the system according to this invention.

### DETAILED DESCRIPTION OF THE INVENTION

The system and method according to the present invention requires the participation of an operator, an administrator, one or more users and one or more clients.

The Operator is the one who knows all aspects of the method and system according to the present invention, the operator is ready to tackle any job and solve any problems the User may have. The operator can:
Prepare the user to enter the virtual environment.
Prepare the system of the present invention so the user can navigate seamlessly into the virtual environment.
Know how the system works.
Enter user data to the system.
Control periferical devices for the Users.
generate and manage reports with graphs obtained with the method of the present invention.

The Administrator, same as the operator, is a person trained to use the method and system according to the present invention. The administrator must be able to manage both customers and report data for each depending on the given information for the research studies.

The Administrator has the authority to change access to the data of different customers, allow access to different filters (such as age ranges or conditions of the respondents), reports (which include listings of time and relevance of groups or all products) and tools (like PDF export or generate map images display samples), the list of filters, reports and tools available depend on the application of analysis of the captured data and this ensures that customers can make different operations on their research data.

The User is the individual object of the analysis; in general the studies are made to a particular group of users within a certain goal.

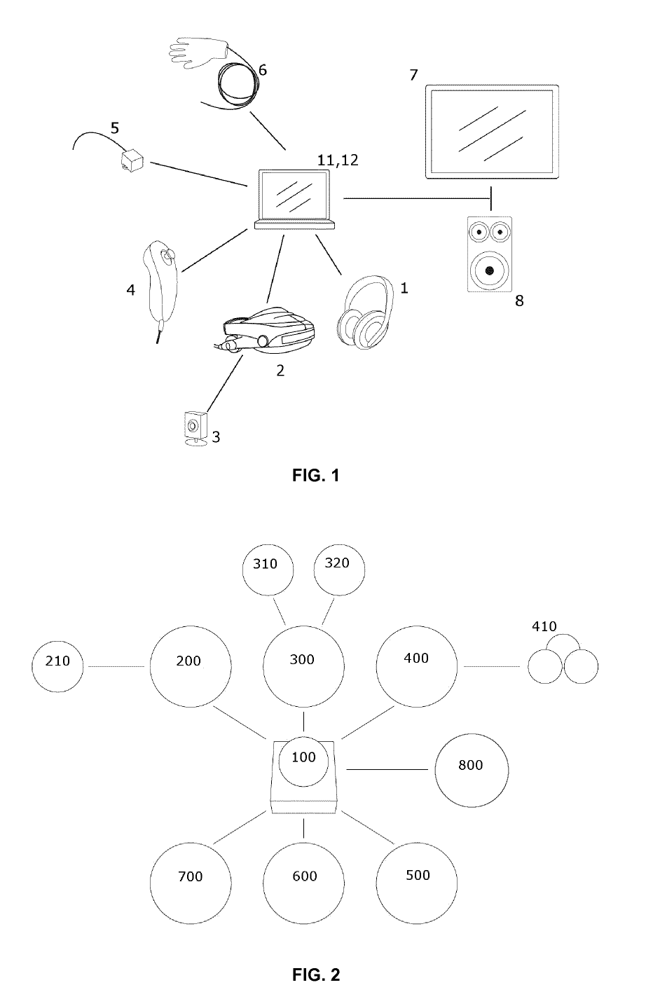

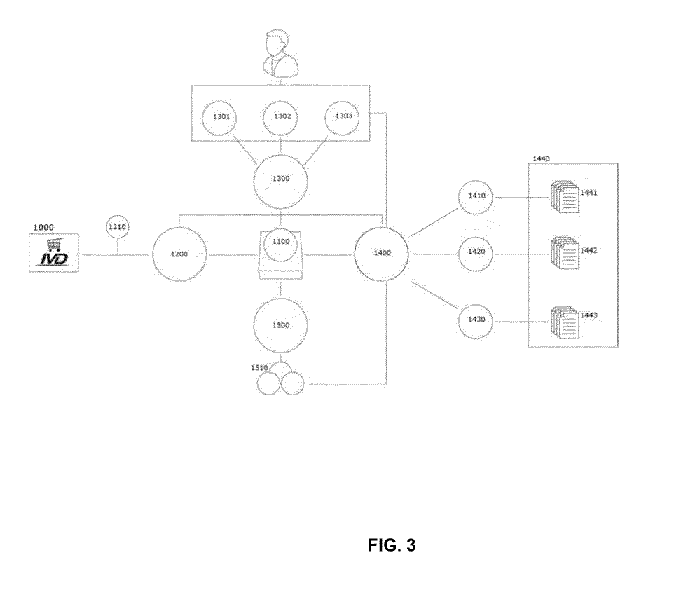

The client is the individual or organization is interested in the results of the analysis, probably the owner or representative of a product, multiple products or advertising. The client is who is contracting the service, is expecting results and conclusions on the analysis of the behavior of the target users, and is accessing the system with the permissions that were granted by the Administrator. In FIG. 1, can be seen the devices used in the Application module of the system of the present invention, on the other hand, FIGS. 2 and 3 illustrate the components of the system of the present invention as described below. The flexible and immersive system for data collection in a virtual environment to study the behavior of users in this virtual environment stimulus comprises:
a) peripheral Devices (410) of control, visualization, audio and capture of the user in the virtual environment;
b) a processor (11) for processing information of the virtual environment and the behavior of the User;
c) a storage medium (12) configured with an application module (1000) in communication with the processor (11) to provide the virtual environment;
d) a dedicated storage medium (not shown in the figures) configured with a On-Line module (1100) in communication with the processor (11) for storing a database with information provided by the application module (1000) on of the virtual environment and the behavior of the user;
e) visualization mediums (14) configured to display graphical representation of said user behavior illustrated by the Core On-Line Module (1100) with the database from the dedicated storage.

In particular, such control devices may alternatively be a joystick (4) or a control glove (6) to allow the user to navigate in the virtual environment.

These devices represent a set of lenses representing the virtual reality (2) and portable headphones (1), optionally may also comprise a of a TV, display, screen or projector (7) to display the virtual environment visible through the set of lenses representing the virtual reality (2), and speakers (8) that play as well as portable headphones (1).

These capture devices consist of a directional device (5) that captures the user's head (headtracking) that is in the virtual reality lenses (2), optionally comprising an eye-tracking device (3) on the virtual reality lenses (2) to record the fixations of said user in the virtual environment, a motion-tracking device (5) to record body movement of the user in the virtual environment and the control glove (6) that captures the user's gestures in the virtual environment. Additionally, the system of the present invention may include means for printing the graphic representations of the behavior of said user, said print media can be printed directly on paper or record in computer readable medium as a CD, a mass storage device, or equivalent or directly send these graphs via a telecommunications network such as the Internet according to customer preferences.

Additionally, as shown in FIG. 2, the application module (1000) system of the present invention is configured with:
Core module (100) comprising an engine of virtual reality and real-time-programmable high-level language and a physical simulation engine in the virtual environment;
Command Descriptor module (200) to enter operator commands to the implementation module (1000), the Command Module Descriptor (200) comprising an Command analyzer (210) to analyze each command entered, and a console component (220) to enter each command and display a response to a command entered;
Training Manager module (300) to familiarize the user with the virtual environment, and is responsible for managing training sessions;
Capture module (400) comprising the information generated by peripheral devices (410) control and capture of the user in this virtual environment, the capture module (400) further comprises the Data Viewer component (430) and the Report generator component (420) and communicates with peripheral devices for control and data capture (410);
Player module (500) comprising user instructions and allows the representation of the user in the virtual environment, the player module (500) further comprises a Products visualizer component (510) for three-dimensional product visualization in the virtual environment in a minimal definition of 800×600 pixels with shading effects using real-time, allowing the simulation of materials;
Scene module (600) comprising a container with descriptions of scenes of the virtual environment and scripts for events in these scenes, these scenes includes descriptions of static and dynamic elements;
Free camera module (700) comprising a reference vector representing a camera moving freely within this virtual environment, and
Communication Protocol Module (1200) comprising a Dictionary component (1210) and which communicates the core On-Line module (1100) with the Application Module (1000).

Additionally, the On-Line module (1100) system of the present invention is configured with:
a Communication Protocol module (1200) comprising the component Dictionary (1210) connects the core On-Line module (1100) with the Application Module (1000);
a Customer Network Interface (1300) for interaction with the client component comprises a report component (1301), a display component (1302) and a Publishing component (1303);
an Abstract Functionality Layer Module (1400) includes a Database (1440), a project component (1410), a user component (1420) and an Other component (1430), this database (1440) includes a Projects table (1441), a user table (1442) and an Others Table (1443); and
an Administration Network Interface (1500) for the interaction of the Administrator and/or operator comprising a management component (1510).

### Core

Core Module (100) comprises a virtual reality engine in real time and high-level programming language and a physical simulation engine in the virtual environment.

An interactive virtual reality engine in real time, such as Unity from Unity Technologies, which can be programmed with libraries from the .NET platform standard allows access to resources via cutting edge high level graphics shading language (HLSL) and in C # that is used to join all the resources and compile an executable from the storage medium (12) with the processor (11). This engine allows programming with high-level languages and program all the interactivity and information generation system and method of the present invention. The interactive real time virtual environment engine is operative with the processor (11) and is stored in said storage medium (12). This core module (100) also contains a physics simulation engine, such as PhysX™ of Ageia™ Technologies, Inc., to achieve optimal detection of volumes of interest by tracing rays from the scene manager to detect those objects colliding with the eye, and then use this information to generate reports. The physical simulation also helps define the geographical area where the user can move. Additionally, the core module (100) includes an application or method of creating three-dimensional models, such as Autodesk Maya®, Inc. and generating a graphical application such as Photoshop® from Adobe Systems Incorporated to create textures and images.

### Command Descriptor

Command Descriptor Module (200) includes the commands entered by the operator and those available in the virtual environment. The virtual environment has scheduled a series of commands that are unique to each module; the Command Descriptor (200) can execute those commands.

A command from the Operator is an instruction with a defined syntax, which lets you alter a variable in the virtual environment. The commands are used to perform any task, from changing the height of the user to display data from the generated studies.

The Definition of all available operator commands reside in the Command descriptor module (200), also it defines if the commands are available in the current scene of the virtual environment scene defined in the module (600), their available attributes, data required by each, the type and format of this data and help messages if the command is not entered properly. The Command Descriptor Module (200) communicates with the core modules (100), The Training Manager (300), Capture (400), player (500), Scene (600) and Free Camera (700).

The Command Descriptor module further comprises a command analyzer component (210) and a Console component (220).

The Commands Analyzer Component (210) includes definitions, syntax and required parameters for each command. The Commands Analyzer Component (210) is in charge of taking a command and analyzes information, identifies each of the elements of the command and then compared with its definition to verify the syntax. In the event that the syntactic construction and logic is correct, the command analyzer component (210) will execute the command; otherwise, it sends a message to the Console component (220) describing the error detected.

The Console component (220) is responsible for receiving operator input and display messages relating to that virtual environment, for it has an interface that is divided into two parts: a board (221) and an input field (222). The Board (221) is a graphic element that shows a history of all messages generated, using a color format to easily identify the message type and shows the time the message was added. The Input Field (222) is a graphic element where the operator can enter a command with the help of a keyboard (223), the operator can type on the keyboard (223) the command needed and press the “Enter” to execute. The operator can also browse the board (221) through the command history with arrow keys up and down arrow on the keyboard (223), this avoids having to type again the previously used commands.

A command can be entered in three ways, automatically via a plain text file (224) that contains a script, using the input field (222), the Board (221) or using peripheral devices (410) with one of the different graphical interfaces created, such as virtual the reality goggles (2) or the optional projector (7). Building a command allows to specify multiple attributes at the same time because each has an associated number of data according to the Command Descriptor Module (200).

### Training

The Training Manager Module (300) uses training scenes and training sessions defined in the Scene module (600) to familiarize the user with the virtual environment, and is responsible for the administration of training sessions. A training session is a set of tasks that a user must perform correctly; these training sessions are to prepare the user within the virtual environment so that you can achieve the best possible experience when used for a research study. These sessions train the user from things as basic as looking around to walk around in the virtual environment and pick up products.

Training sessions are tailored to the different characteristics of target users for the study according to the customer's requirements. Every training session Executed communicates with the Capture Manager module (400) and its Report Builder component (430) to deliver a report with results. times and the path that the user used when executing their tasks, so that the operator can then analyze how the user adapted to the system of the present invention. These reports can be displayed on a console, or saved to file in plain text format using the Data Viewer component (420).

A training session consists of a set of tasks, each task consists of several instructions and each instruction represents an event or change in job status.

A training session includes an entry task and one or more training tasks. When a user starts a training session, the task is runned which is defined as the input task, which is where the training session starts, with for example an introduction and preparation to continue the rest of the training tasks. Each task defines its output corresponding to an event to get somewhere or observe an object and the output is equivalent to start another task or completion of training.

Each task consists of a sequence of instructions, each instruction represents an event, such as “Seeing red sphere” which is assigned a name that serves to associate a particular output, or a change of state, such as “Show: Welcome to IVD.” A task can have multiple outputs, this controls the flow of the workout, such as another particular output can be generated when the user falls off a platform then the output is an instruction to restart the current task, so the running task will rerun from the start, yet another particular output can be generated when the user reaches a target then the output is a reference for the next task.

Through events and instructions one can even assemble scenes of the module Scene (600) through decisions of the user, where the user decides his next task, thus having more freedom to go over some instructions in case it deems appropriate.

### Capture

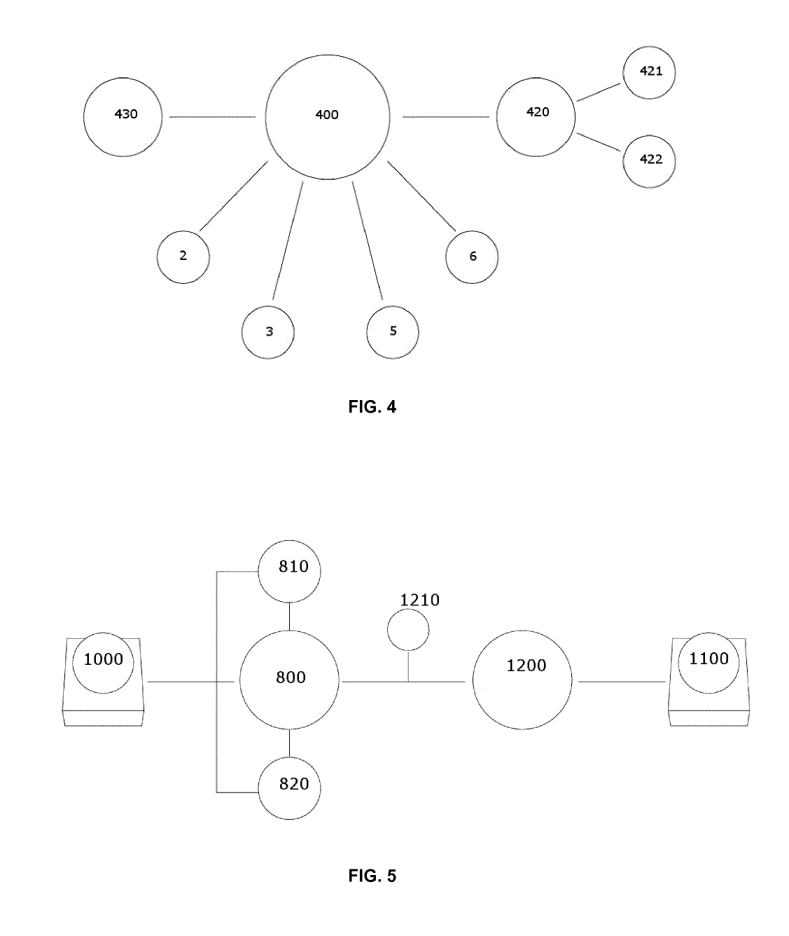

As shown in FIG. 4, the capture module (400) comprises information generated by peripheral capture devices (410) like the directional capture of head movement device of the virtual lenses (2), eye-tracking device (3), the body motion capture device (5) and the control glove (6) of the User in the virtual environment. The capture module (400) further comprises of the Data Viewer component (430) and the Report Builder component (420) and communicates with peripheral control and capture devices (410).

The capture is a real-time collection of actions that you perform in this way you can reconstruct your route based on this data collection.

The main functions of the capture module (400) include:
data recording of user behavior by signals from peripheral devices (410);
save behavior data to a file in mentioned storage medium (12);
load behavior data from a file;
generate reports and statistics;
play behavior data in real time and
communicate with a central server to store behavior data remotely.

The Recording of behavioral data from a user is performed by peripheral control and capture devices (410) and are based on two parameters: duration and interval. The length determines how long the user's behavior to be recorded while the interval defines how many samples will be taken during that time.

The duration and interval are specified in seconds; however, to achieve good reconstructions of the performance curves it is recommended to specify intervals of less than 1 second. Values range between 0.05 and 0.15 seconds are good choices because they provide a minor error in the reconstruction of the performance curve. Usually, we use an interval of 0.15 seconds and can be adjusted dynamically. This interval should always be less than the time of fixation provided below.

Optionally, the eye-tracking device (103) refines the values listed above.

According to the “Eye Movement in Reading and Information Processing: 20 Years of Research” Psychological Bulletin, Keith Rayner, 124 (3), 372-422, 1998, an individual stares at a point if the time is less than one value between 0.2 to 0.3 seconds, so in the virtual environment, for intervals of 0.2 to 0.3 seconds, a fixation is defined theoretically in a product or brand.

The performance data files that the capture module (400) uses are in XML format, XML is a W3C standard, widely recognized and used, so its use is easy because the whole system according to the present invention uses XML as data the communication format.

Data Display Component (430) represents the performance data of a recording in real time using peripheral devices (410) in the virtual environment. The data Display Component (430) and the core module (100) process stored behavior data make this in the virtual environment visual objects in different formats depending on what you want to analyze. These visual objects can be hidden, combined, filtered, and so on. So that the information is as clear as possible. Different formats can be combined, filtered, split, go, saved and recovered.

The capture module (400) further comprises a Report Generator component (420) that generates reports that can be sent to a console (428), a data server that contains all the information from research or directly to a file (421). The reports are representations of performance data mainly transformed into information that can be understood by a person interested in the research studyies of behavior of individuals in order to obtain logical conclusions from them.

The Report Generator component (420) formats performance data and sends them to the corresponding output, ie to a console, a data server or directly to a file. Included are three formats that are most required, plain text format, XML format and work template. The plain text format formats the data so that behavior can be displayed and analyzed at the time of opening the text file, it contains appropriate clearances and the data is grouped in tabular form. On the other hand, the work template is formatted by adding special characters within the data so that when imported into an Excel or SPSS template.

### Player

The player module (500) includes user instructions and allows the representation of the user in the virtual environment. All that the user performs is sent from the peripheral control and capture devices (410) to this Player module (500) for interpretation as user instructions. In particular, the gaze direction of the user is detected by the headtracking together with Eye-tracking.

The User Instructions this player module (500) contains are:
walking forward;
walking backwards;
turn the head and body independently;
bending and standing up straight;
panorama view;
observe a detail of the virtual environment;
take a product in the virtual environment;
let go of a a product in the virtual environment;
purchase a product in the virtual environment, and
cancel the purchase of a product in virtual environment.

The virtual environment of the present invention accurately reflects each of these actions, so that the user is as much immersed in this experience as possible, for which the Player module (500) sends User instructions to the core module (100) for its processing in the virtual environment.

The player module (500) is active only when the operator deems appropriate, whether for study, training or to explain the operation of the system and only in the necessary scenes.

Additionally, the player module (500) simulates the height of the user. When the height of a user changes the player module (500) adjusts the height of vision within the virtual environment to ensure consistency between what the user sees in the virtual environment and what would in reality.

The height of view is different from the height of the user, a percentage of the height of the person is determined as the average eye level, this percentage is used to calculate the height of vision, which is where you put the virtual reality lenses to based on the user's height, for the average person uses a percentage of 93.8% for men and 94% for women according to the International Encyclopedia of Ergonomics and Human Factors, Waldemar Karwawski, page 912.

Finally, the player module (500) is also responsible for checking that the user stays within the limits for a particular layout, for example, it does not cross aisles of products or leaves the store. The limits are defined by collisions, which are structures defined in the virtual reality engine to detect if the user is geographically in a particular geographic area of the virtual environment.

The player module (500) further comprises a Products display component (510) which depends strictly on user instructions received from the player module (500). The Products Display Component (510) includes three-dimensional product displays in the virtual environment to be studied at a definition of 800×600 pixels, and allows visualization using shading effects in real time allowing the simulation of materials. The high definition display of products help observing all the details you can have both on the label and in the material, this is especially useful in products that are in testing phase before production. The material and graphical content of the product also interacts with different effects of shadows, reflections and illumination of the virtual environment, allowing a more realistic appreciation of the object. When a product is represented in high definition, the user can view from any angle, as well as zoom, so this Products Display component (510) comprise the following product instructions:
Display product:
turn the product;
zoom in on product;
zoom out on product.

### Scene

The Scene module (600) comprises a container with descriptions of scenes of the virtual environment and scripts for events in these scenes. Each scene in the virtual environment is represented by a scene description containing all the elements needed to generate the content of the scene. Proper operation depends exclusively on the scene description that includes static and dynamic elements. Static elements are all elements that have no user interaction such as walls, shelves and more. Dynamic elements are all ones that can interact with the user such as products or objects that can be enabled or disabled as required by the scene.

The Scene module (600) further comprises a main menu that contains all valid scenes that can be accessed within the virtual environment, as well as training scenes and study scene.

A scene from training or study is a description of scene that has the description of different rooms where defined tasks are executed, the present objects, lighting, event areas, and others. Also each scene description includes a script session with the tasks and instructions to be used in training or a behavioral study.

### Free Camera

The Free camera module (700) comprises a mobile reference vector representing a free camera within this virtual environment. In the player module (500), the user has the freedom to move within a virtual space (a store) as you want and where you want, but always within the limits of the scene description that the Scene module (600) provides. Instead, the Free camera module (700) provides the functionality of a virtual camera that can move in any direction at any time. Its main function is to visualize what exists in the virtual environment from angles that the user could not accomplish in the Player module (500). The Free camera module (700) enables real-time view at different angles of the same situation that fit exactly the needs that may arise and may not necessarily be achieved with the player simulation module (500) in the virtual environment.

### Visualizer

As shown in FIG. 5, the visualizer module (800) includes a Views component (810) and a control component (820). The visualizer module (800) is an essential component of the present invention to display significant amounts of samples and generate reports based on customer requirements. The visualizer module (800) communicates through Communication Protocol

Module (1200) with the functionality Abstraction Layer module (1400) and is defined in the application module (1000) and the On-Line module (1100) for all screenshots used on a particular display. It then sends these data to the Views (810) who is responsible for generating the visualization. This module obtains display setting information from the controller module. Finally, the display receives the visualization and all necessary structures to make it physically visible on the screen, so the customer can print or save the report and visualization generated.

The display module (800) represents the final instance in which the data captured by a study is used to generate information relevant to customer interest. That's why it is analyzed as a separate and independent component. It provides an advanced level of interactivity, allowing the user to adjust the display to its needs.

The displays are the way the samples are deployed on a two-dimensional image equivalent to the image provided in the virtual environment when the samples were captured by the capture devices. There are several types of displays, including but not limited to those described below:
Samples: Samples are represented by dots that represent the fixation points of the user's gaze in that virtual environment, one point per sample, which can have different shapes and colors.
Areas of high and low density: The samples are represented by a map shown in two colors, one representing the places where there is a high density of samples and the other places where there is a low density of samples. The density limit can be adjusted.
Density Gradient: Same as areas of high and low density, only it works with 256 different levels of density in the samples, which can be illustrated by a gradient of two or more colors to view each of the levels and transition between them.
Areas with higher density: means a number of areas with the highest density of samples are displayed in a list sorted by density showing the time each of the areas in question where seen.
Flow of Vectors: This display shows the flow of vectors that reached a particular object within that virtual environment, describing the path of the eye before seeing the object, so you can visualize the relevance or the attraction of the object relative to its neighbors.

In the viewer component (810) all visualizations are processed and than returned in the necessary structures to make them properly visible, including dynamic lists, textures, materials, ramps, position, time, products, Vectors, Filters and Images. The displays have a direct relationship with the controls, because since they contain the data necessary for adjustments of each of the visualizations.

In the control component (820), controls help adjust each visualization separately, you can assign textures, gradients, colors, materials, supplies, forms, etc., depending on the display. Each display has a certain amount of configurable parameters.

The different configurations of controls and adjustments can be stored for later use with different samples.

Within the controls include settings for:
Textures
Gradients
Forms
Colors
Materials
Positions
Totals
Visible Elements
Other settings

### Online

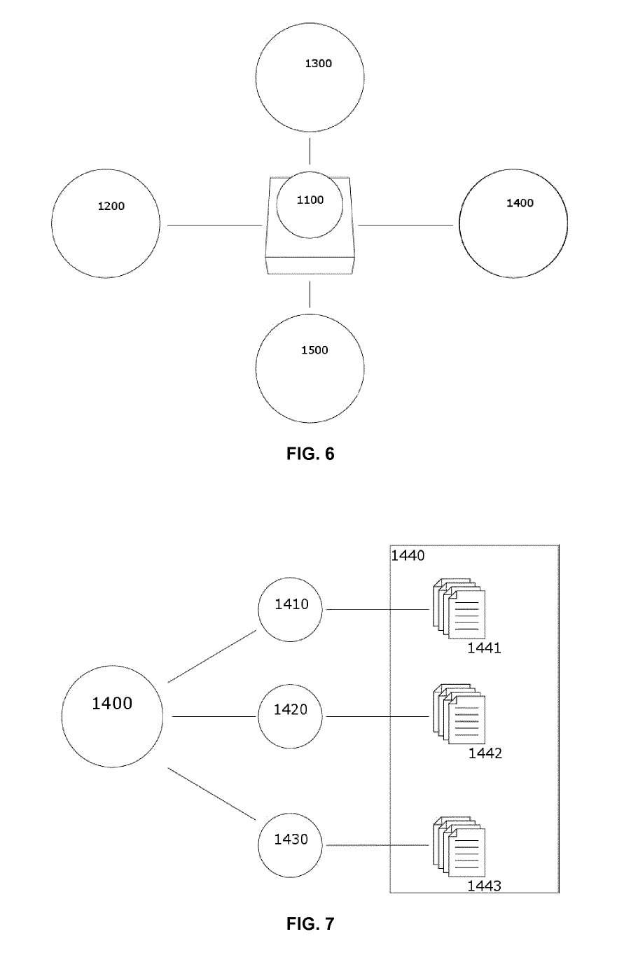

As shown in FIG. 6, the Core On-Line Module (1100) centralized remote operations of the User, the Customer, the Operator and Manager. The On-Line Module (1100) includes:
A Communication Protocol Module (1200);
A Customer Interface (1300);
A Abstract layer of functionality module (1400), and
Manager interface (1500).

Module On-Line (1100) allows the connection between users, operators, managers and clients remotely via the communication protocol module (1200), to centralize and organize the information into a database using the abstraction layer of functionality module (1400), reporting to the customer quickly and securely through the Client Interface module (1300), projects are administered by a trained person at any time and from anywhere via the Administrator interface module (1500).

### Communication Protocol

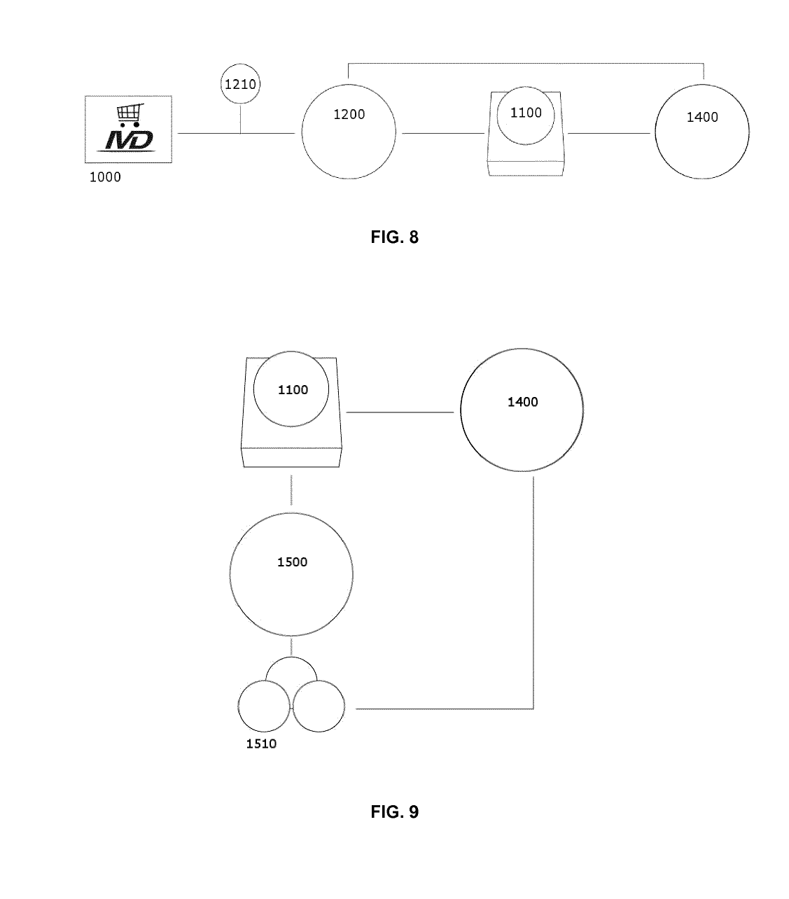

As shown in FIG. 8, a Communication Protocol Module (1200) comprising the Dictionary component (1210) connects the core on-Line module (1100) with the Application Module (1000). The Communication Protocol Module (1200) receives a request from the application module (1000), validates if the request is correct and sends it to the Abstract Layer Functionality module (1400).

To communicate the Dictionary component (1210) is used, which transforms the information contained in the request to the XML format or another format that allows to be passed through HTTP Requests.

The Communication Protocol Module (1200) uses the Abstract Layer Functionality module (1400) for all inquiries, so it has no direct interaction with the database (1440) and transmits the information structured according to the abstraction layer of functionality module (1400).

### Customer Network Interface

As shown in FIG. 10, the Customer Network Interface (1300) for interaction with the client comprises a report component (1301), a display component (1302) and a Publishing component (1303).

The Customer Network Interface (1300) sets out the relevant research data to the Client, who is most interested in the research and what can be concluded by it. The Customer Network Interface (1300) is able to display reports and graphs of the behavior of said user in said virtual environment in different ways, helping the interpretation and conclusion of the data, and therefore the decision-making.

The Customer Network Interface (1300) includes a set of functions on surveys and interviews among others, these functions communicate with the Abstract Functionality Layer module (1400) to retrieve the structured information stored for each of the functions. These functions use the modules of the present invention to represent information so that the client can understand it, whether in pictures, bar graphs, XML data, tables or reports.

The main functions are:
Reporting is responsible for generating a report humanly friendly from a collection of data, generally in readable language and helped with some images.
Views is responsibe for obtaining and deliver data to make possible the different views of the system, which communicates with the visualization module (800) by the Communication Protocol Module (1200).
Publications: Its function is to publish images associated with the visualizations but with a more conceptual character, i.e., products or gondola.

### Abstract Layer Functionality

As shown in FIG. 7, the abstract layer of functionality module (1400) includes a Database (1440), a project component (1410), a user component (1420) and a Other component (1430). This Database (1440) includes a Projects Table (1441), a user table (1442) and an Others Table (1443).

The Abstract Layer Functionality module (1400) is responsible for communicating with the database (1440) for all necessary consultations, thus, represents a conceptual layer that abstracts from the rest of the SQL query modules changing them for conceptual more human-friendly function, such as “Get Active Projects” or “Save capture”.

This Abstract Functionality Layer module (1400) is composed in turn by a certain number of components responsible for specific instructions within the database, the project component (1410) communicates with the Table of Projects (1441) of the Database (1440) and is responsible for all queries related to research projects such as: Get active projects, on/off project, get information about a particular project, the user component (1420) communicates with the Username Table (1442) of the Database (1440) for information related to user behavior and the Other component (1430) communicates with the Others Table (1443) of the Database (1440) for various information not related directly to the user or the project for a client.

Optionally, the Abstract Functionality Layer module (1400) includes a component Help, a component that is not necessarily a specific function within the system or important but is used to help other components, so that each one remains on the task in particularly, but will not incur in performance problems every time it is called.

The components of this abstract Functionality layer module (1400) are used to encapsulate the functionality of the system and load code only when needed, thus optimizing the execution of scripts.

In The Abstract Functionality Layer module (1400) and in each of the components the data structure defined in component Dictionary (1210) of the Communication Protocol Module (1200) is used to standardize the queries that can be performed.

### Network Management Interface

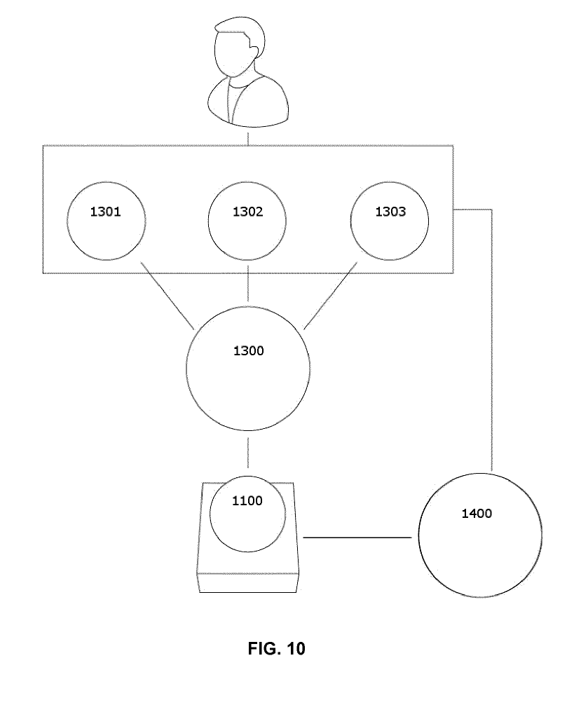

As shown in FIG. 9, a Network Management Interface (1500) for interaction with the Administrator and/or operator comprising a management component (1510).

The Network Management Interface (1500) includes a set of functions within the concept of Model View Controller (MVC) using the Abstract Layer Functionality module (1400) to obtain and modify information in the database (1440). It contains a function, which administrates Project (1510) that communicates with the Projects Table (1441), a function administrates User (1520) which communicates with the user table (1442) and an other function administrates Other (1530) that communicates with the Others Table (1443).

The configuration of the complete system of the present invention is executed by an administrator, or more, through the Network Interface Administration Module (1500) so the critical system settings and individual research projects are protected from the rest of the application via a user access control, administrators and permission control to change or view records.

The Network Management Interface (1500) allows the following, but is not limited to:
Initiate new research;
Set these research sessions, interviews, dates, places, etc.;
Add consumers to a particular session;
Manage clients;
Add, block and delete users, and
Assign access permissions.

### Method According to the Invention

The Flexible method to generate an immersive research study of the behavior of a user regarding stimuli in a virtual environment comprising:

a) providing to the user peripherals for control, display, audio and capture (410);
b) provide an operator with a processor (11) for processing information of the virtual environment and the behavior of said user and a storage medium (12) configured with an application module (1000) in communication with the processor (11) to provide the virtual environment;
c) provide to an Administrator a storage medium configured with a dedicated On-Line module (1100) in communication with the processor (11) for storing a Data Base (1440) with information provided by the Application Module (1000) of the virtual environment and the user behavior and network management interface that includes a set of functions to get and modify information in the database (1440);
d) provide a Customer Network Interface to show reports and graphs of the behavior of that user in the virtual environment;
e) communicate a user description for an Operator Command descriptor module (200) to a player module (500), wherein said command module descriptor (200) and said module player (500) defined in the Application module (1000) and the Command Module Descriptor (200) comprises Operator commands available in that virtual environment;
f) communicating a scene description (601) with a Script (602) from a Scene module (600) to a Core module (100), this Scene module (600) and Core module (100) defined within the Application module (1000), the Scene module (600) comprises a container of scene descriptions of the virtual environment and scripts for events in these scenes;
g) generating a virtual environment according to said scene description (601) and Script (602) by the Core module (100) comprising a virtual reality engine for real-time interactive and programmable high-level language and a physical simulation engine in that virtual environment;
h) to visualize the virtual environment to the user by that player module (500) comprising User's instructions that are executed as the User actions received from peripheral control devices (410) to interpret the user's behavior in this virtual environment;
i) recording the movement, actions and the path of the eye of the user in the virtual environment using a apture module (400) with the information generated by the capture devices of the individual in the virtual environment, wherein said Capture module (400) is defined in the application module (100);
j) communicate the record of the Capture module to (400) through a communication protocol module (1200) to a Functional Abstraction Layer module (1400), where the modules Communication Protocol (1200) and Functional Abstraction Layer (1400) are defined in the On-Line module (1100);
k) storing the record of the capture module (400) connected by Communication Protocol Module (1200) in a Database (1440) through the Functional Abstraction Layer module (1400) in that dedicated storage medium as structured information;
l) communicate such structured information through the Communication Protocol Module (1200) to the display module (800) defined in the Application Module (1000);
m) illustrate this structured information in the visualization module (800) by the viewer component (810) on a display (14) to Customer according to the specifications provided by Client, Administrator and/or operator in the control component (810), where the components Views (810) and Control (820) are defined in the visualization module (800); and
n) generate a study report of user behavior in the virtual environment using the report component (830) defined in the visualization module (800) according to the specifications of the control component (810).

In particular, generate a report of the research of user behavior in the virtual environment according to the method of the present invention comprises generating:
Samples represented by points that represent the fixation points of the user's gaze in that virtual environment;
Areas of high and low density represented in a map that shows a color where there are high-density samples and other color represents places with low density of samples;
Density gradient that works with 256 different levels of density in the samples, which can be illustrated by a gradient of two or more colors to display each of the levels and the transition between them;
Higher density areas are displayed in a list sorted by density showing the times each of these areas was seen, and/or

Flow of Vectors which reached a particular object within that virtual environment, describing the path of the eye before running into the object, it can visualize the relevance or attractiveness of the object relative to its neighbors. Additionally, the method of the present invention comprises delivering a research report about user behavior in the virtual environment with a Customer Network Interface (1300) through a report component (1301), a visualization component (1302) and/or Publication component (1303).

Optionally, the method of the present invention comprises a later stage): to communicate to the Scene module (600) the beginning of a training sesion from a Training Manager module (300) and in step b), the description of Scene (601) corresponding to a training scene and the Script (602) corresponds to a training script, to conduct a training session with the user.

In particular, the method of the present invention comprises performing a series of training tasks by the user in the training session of the user.

1. A system of data collection in a virtual environment to study the behavior of a user regarding the virtual environment stimuli, which is sufficiently flexible and immersive as to develop a custom application for an accurate analysis of the behavior of a consumer, comprising:
a) Peripheral control Devices (410) that allow the user to navigate in the virtual environment, peripheral representation devices that deliver a representation of the virtual environment, and peripheral capture devices that allow to record information of the user in response to stimuli from the virtual environment;
b) a processor (11) for processing information of the virtual environment and the behavior of said user obtained by capture devices;
c) a storage medium (12) configured with an Application module (1000) in communication with the processor (11) to provide the virtual environment;
d) a dedicated storage medium (not shown in the figures) configured with a On-Line module (1100) in communication with the processor (11) for storing a database with information provided by the Application module (1000) on of the virtual environment and the behavior of said user, and
e) Visualization means (14) configured to display graphical representation of said user behavior illustrated by the Core On-Line Module (1100) with the database through dedicated storage;
wherein said peripheral devices (410) representing a virtual reality lens (2) and portable headphones (1) in the virtual reality lens (2) comprises inside a peripheral capture device for a eye tracking (3), to record the eye movement of said user in this virtual environment.

2. The system according to claim 1, wherein said peripheral control devices (410) can be a control knob (joystick) (4) and/or a control glove (6) to allow the user to move in the virtual environment.

3. The system according to claim 1, wherein said optional peripheral representation devices (410) include a TV or projector and screen (7) and speakers (8).

4. The system according to claim 1, wherein said peripheral capture devices (410) is a directional head tracking that is in the virtual reality lens (2).

5. The system according to claim 1, wherein said peripheral capture devices (410) further comprises a body motion tracker (5) to record body movement of the user in the virtual environment and the glove control (6) that capture the user's gestures in the virtual environment.

6. The system according to claim 1, wherein said includes means for printing the graphic representations of the behavior of said user, wherein said printing means you can print directly on paper or save in a readable format as a CD, a mass storage device, or equivalent or directly send these graphs via a telecommunications network such as the Internet according to customer preferences.

7. The system according to claim 1, wherein the application module (1000) is configured with:
a Core module (100) comprising an virtual reality engine in real-time-and programmable in high-level language and a physical simulation engine in the virtual environment;
a Command Descriptor module (200) to enter operator commands to the Application module (1000), the Command Descriptor Module (200) comprising an Command analyzer (210) to analyze each command entered, and a console component (220) to enter each command and display a response to a command entered;
a Training Manager module (300) to familiarize the user with the virtual environment, and is responsible for managing training sessions;
a Capture module (400) comprising the information generated by peripheral control and capture devices (410) of the user in this virtual environment, the capture module (400) further comprises the Data Viewer component (430) and the Report generator component (420) and communicates with peripheral control and capture devices (410);
a Player module (500) comprising user instructions and allows the representation of the user in the virtual environment, the player module (500) further comprises a Products display component (510) for three-dimensional product displays in the virtual environment in a minimal definition 800×600 pixel using real-time shading effects allowing the simulation of materials;
a Scene module (600) comprising a container of scene descriptions of the virtual environment and scripts for events in these scenes, these scenes includes descriptions of static and dynamic elements;
a Free camera module (700) comprising a reference vector representing a camera moving freely within this virtual environment, and
a Communication Protocol Module (1200) comprising a Dictionary component (1210) and communicates the core On-Line module (1100) with the Application Module (1000).

8. The system according to claim 7, wherein the On-Line module (1100) of the system of the present invention is configured with:
a Communication Protocol module (1200) that comprising the Dictionary component (1210) connects the core On-Line module (1100) with the Application Module (1000);
a Customer Network Interface (1300) for interaction with the client comprises a report component (1301), a visualization component (1302) and a Publishing component (1303);
a Abstract Functionality Layer Module (1400) includes a Database (1440), a project component (1410), a user component (1420) and a Other component (1430), this database (1440) includes a Projects table (1441), a user table (1442) and an Others Table (1443);
a Network administration Interface (1500) for the interaction of the Administrator and/or operator comprising a administration component (1510).

9. A method to generate a study of the behavior of users regarding stimuli in a virtual environment, which is sufficiently flexible and immersive as to develop a custom application to an accurate analysis of the behavior of a consumer, which comprises:
a) providing the user peripherals, for control, display, audio and capture (410);
b) provide an operator a processor (11) for processing information of the virtual environment and the behavior of said user and a storage medium (12) configured with an application module (1000) in communication with the processor (11) to provide the virtual environment;
c) to provide the Administrator a storage medium configured with a dedicated On-Line module (1100) in communication with the processor (11) for storing a Data Base (1440) with information provided by the Application Module (1000) on the virtual environment and the user behavior and network management interface that includes a set of functions to get and modify information in the database (1440);
d) to provide a Customer a Customer Network Interface to show reports and graphs of the behavior of that user in the virtual environment;
e) communicating a user description for an Operator through a module descriptor Command (200) to a player module (500), wherein said Command module descriptor (200) and said module player (500) defined in the Application Module (1000) and the Command Module Descriptor (200) comprises Operator commands available in that virtual environment;
f) communicating a scene description (601) with a Script (602) from a module Scene (600) to a core module (100), these Scene (600) and Core (100) modules defined within the application module (1000), the Scene module (600) comprises a container with scene descriptions of the virtual environment and scripts for events in these scenes;
g) generating a virtual environment according to said scene description (601) and Script (602) by the core module (100) comprising an interactive virtual reality engine in real-time and a programmable high-level language and a physics simulation engine in that virtual environment;
h) to visualize the virtual environment to the user by that player module (500) comprising user instructions that are executed as the User's actions received from peripheral control devices (410) to interpret the user's behavior in this virtual environment;
i) recording the movement, actions and the path of the eye of the user in the virtual environment using a capture module (400) with the information generated by the capture of individual devices in the virtual environment, wherein said capture module (400) is defined in the application module (100);
j) to communicate the record of the Capture module (400) through a communication protocol module (1200) to a Functional Abstraction Layer module (1400), where the Communication Protocol modules (1200) and Functional Abstraction Layer (1400) are defined in the On-Line module (1100);
k) storing the record of the capture module (400) connected by Communication Protocol Module (1200) in a Database (1440) through a Functional Abstraction Layer module (1400) in that dedicated storage medium as structured information;
l) communicate such structured information through the Communication Protocol Module (1200) to the display module (800) defined in the Application Module (1000);
m) illustrate this structured information in the display module (800) by the visualizer component (810) on a display means (14) to the Customer according to the specifications provided by Client, Administrator and/or operator in the control component (810), where the visualization components (810) and Control component (820) are defined in the display module (800), and
n) generate a study report of user behavior in the virtual environment using the report component (830) defined in the display module (800) according to the specifications of the control component (810).

10. The method according to claim 9, wherein the generation of a report of the study of user behavior in the virtual environment according to the method of the present invention comprises generating:
Samples represented by points that represent the fixation points of the user's gaze in that virtual environment;
Areas of high and low density represented in a map that shows a color where there is a high density of samples and other color represents places with low density of samples;
Density gradient that works with 256 different levels of density in the samples, which can be illustrated by a gradient of two or more colors to display each of the levels and the transition between them;
Higher density areas are displayed in a list sorted by density showing the times each of these areas was seen, and/or
Flow Vectors which reached a particular object within the virtual environment, describing the path of the eye before looking at the same object, it shows the relevance or the attraction of the object relative to its neighbors.

11. The method according to claim 9, wherein further comprises delivering a research report to study user behavior in the virtual environment with a Customer Network Interface (1300) through a Report component (1301), a Display component (1302) and/or Publishing component (1303).

12. The method according to claim 9, wherein optionally comprises a subsequent step a): to communicate to the Scene module (600) the beginning of a training session from a Training Manager module (300) and step b) a description of Scene (601) corresponds to a training scene and the Script (602) corresponds to a training script, to conduct a training session with the user.
